(19) United States
(12) Patent Application Publication
(10) Pub. No.: US 2021/0025491 A1
(43) Pub. Date: Jan. 28, 2021

(54) FLUSHING OF HYDRAULIC FLUID ON START-UP

(71) Applicant: POCLAIN HYDRAULICS INDUSTRIE, Verberie (FR)

(72) Inventor: Ante BOZIC, Verberie (FR)

(21) Appl. No.: 16/754,587

(22) PCT Filed: Oct. 8, 2018
(86) PCT No.: PCT/EP2018/077277

§ 371 Date: Aug. 3, 2020

(30) Foreign Application Priority Data
Oct. 9, 2017 (FR) 1759432

(51) Int. Cl. F16H 61/4139; F16H 61/4192; B60K 17/10; B60K 23/00

(52) U.S. Cl. CPC F16H 61/4139; B60K 23/00; B60K 17/10; F16H 61/4192

(57) ABSTRACT

The invention relates to a self-maintenance system (1) for a vehicle hydraulic assistance device (2), the said device (2) comprising a hydraulic machine (21, 23), the said hydraulic machine (21, 23) being configured to be brought into operation, or deactivated, alternately, the bringing-into-operation and the deactivation being afforded by movement of bringing-into-operation moving parts (211, 231), and the engagement and disengagement of the assistance being operable on command, the system (1) comprising a control module (11) configured to command the bringing into operation of the hydraulic machine (21, 23) for a predetermined length of time and then command deactivation of the hydraulic machine (21, 23) so as to flush all or part of the hydraulic machine (21, 23), the said commands being independent of a command to engage and disengage the assistance.

### TECHNICAL FIELD

The invention relates to a method and a self-maintenance system of a hydraulic assistance device of a vehicle.

The invention more specifically addresses the self-maintenance of a hydraulic assistance device that is little used and/or the hydraulic fluid of which is worn out.

### PRIOR ART

For the purpose of proposing an additional drive for one or more wheels of a vehicle, many hydraulic assistance devices with traction, or temporary hydraulic transition, for vehicles have been proposed.

These devices generally implement at least two hydraulic machines put in fluid communication and configured to convert a pressure difference between their inlet and their outlet into a drive torque, and reciprocally.

Typically, such devices comprise a hydraulic pump, the so-called power pump, linked to the powertrain of the vehicle, said power pump outputting into one or more hydraulic motors linked to the non-driving wheels. Thus, it is possible to transition from a propulsion of the vehicle of 4×2 type to propulsion of 4×4 type, for example in environments where the vehicle is at risk of skidding.

Alternatively, the assistance comprises a first hydraulic machine linked to the front axle of the vehicle, and a second hydraulic machine linked to the rear axle of the vehicle. These two machines can alternatively play the role of power pump or hydraulic motor, according to the needs for an additional drive required by one or the other of the axles. This type of device is conventionally referred to as a “chain drive”, and also makes it possible to convert a 4×2 vehicle into a 4×4 one.

In any case, such systems are disengageable, so as to be able to engage or disengage the assistance according to a command of the user and/or the driving conditions of the vehicle, for example at given speed thresholds, or at a skid threshold. Moreover, these devices are controllable on command, by an automaton or a user, such as to constantly monitor the assistance provided to the wheels.

Thus, an assistance system which would only, for example, be engaged to avoid skidding, could stay unengaged for a very long time. For example, a vehicle endowed with such a system which would only activate the assistance in the event of snow. It is thus possible that, in certain countries, the assistance never engages during most of the year.

The hydraulic machines of such systems generally comprise an assembly of movable parts, in relative movement with respect to one another under the action of a hydraulic fluid circulating within the hydraulic machines. However, to ensure the correct operation of such machines, it is necessary to regularly activate the movement of the movable parts, in order to avoid the appearance of wear or corrosion at the level of the contact points, or deposits at different places, in particular in the bottoms and the filters. The contact of immovable parts can cause a localized abrasion when the vehicle receives the vibrations from driving. The deposits can cause a certain polymerization, the sticking of parts, or the clogging of strainers, which risks damaging the surface at the moment when the machines are started again after a long time without activity, and considerably reduces their lifetime.

Furthermore, the high operating temperatures of such machines can cause the premature ageing of the operating fluid by heating of stagnant deposits, at certain particularly hot localized places. A portion of fluid kept immovable in this part of the system would be regularly heated and could then be locally degraded. This degraded fluid could polymerize and create a blockage, or travel through the system at the first starting-up and become placed on a strainer or a small mechanism. This is particularly problematic when the fluid circuits of the assistance devices are equipped with filtering systems with the aim of preventing the ingestion of impurities by the components of the device. Typically, it is usual to endow the feed pump of such circuits with a filtering strainer at the point of suction of hydraulic fluid from the reservoir. The fouling of this strainer can make the assistance system unavailable due to the fact that the feed pump would no longer be capable of sucking through this strainer, and therefore of creating the pressure necessary for the engagement. This considerably reduces the use time between two drainages of the system.

Besides the reduction of the lifetime of hydraulic assistance devices, the previously described drawbacks require regular maintenance by a professional. This maintenance can turn out to be costly and time-consuming for the user.

There is therefore a need to ensure the long-term availability of the hydraulic assistance devices without compromising the safety of the vehicle.

### SUMMARY OF THE INVENTION

One aim of the invention is to provide continuous self-maintenance of a hydraulic assistance device of a vehicle without altering the structure of the device.

Another aim of the invention is to increase the lifetime of a hydraulic assistance device in an inexpensive way.

Another aim of the invention is to increase the time interval separating two drainages of a hydraulic assistance device of a vehicle.

The invention particularly proposes a self-maintenance system of a hydraulic assistance device of a vehicle, said device comprising a hydraulic machine, said hydraulic machine comprising:
a fluid inlet,
a fluid outlet, and
elements movable under the action of a hydraulic fluid circulating within the hydraulic machine.
   said hydraulic machine being configured to:
convert a pressure difference between the fluid inlet and the fluid outlet into a drive torque, and reciprocally, such as to provide the hydraulic assistance, the conversion being implemented by the movement of movable elements, and
be alternatively:
   operated such as to engage the hydraulic assistance, or
   disabled such as to disengage the hydraulic assistance, the operating and the disabling being provided by the movement of starting movable elements, and the engagement and disengagement of the assistance being controllable on command,
      the system comprising a controlling module configured to command the operating of the hydraulic machine during a determined time period, then command the disabling of the hydraulic machine at the end of said time period such as to ensure the flushing of all or part of the hydraulic machine, said operating and disabling commands being independent of a command of engagement and disengagement of the assistance.

In such a self-maintenance system, the controlling module regularly forces the circulation of fluid within all or part of the hydraulic machine, by complete or partial flushing of the hydraulic machine, which avoids the formation of deposits between the parts. This intermittent forcing is furthermore independent of commands of engagement and/or disengagement of the hydraulic assistance. Thus, the conservation of the quality of the hydraulic fluid of the hydraulic assistance system is made possible, reducing and homogenizing its wear over the whole volume of the system, even if the system is not regularly stressed. This is referred to as continuous self-maintenance of the hydraulic system. It should be noted that such self-maintenance is different from the periodic maintenance operation performed by a professional, which consists in changing the hydraulic fluid, and where applicable the filters of the hydraulic assistance system. Furthermore, such a system offers the advantage of not modifying the existing hydraulic assistance device structures, while significantly increasing the lifetime by limiting the damage due to portions of stagnant fluid. Finally, such a system makes it possible to significantly increase the time interval separating two successive drainages of the assistance device.

The system according to the invention can further comprise the following features taken alone or in combination:
the device further comprises:
   a reservoir, and
   a feed pump, the feed pump comprising:
      a fluid inlet put in fluid communication with the reservoir, and
      a fluid outlet put in fluid communication with the hydraulic machine,
the pump being configured to circulate the hydraulic fluid alternatively:
   from the reservoir to the hydraulic machine, through activation of the feed pump, to operate the hydraulic machine, and
   from the hydraulic machine to the reservoir to disable the hydraulic machine.
the controlling module being configured to command the feed pump,
the starting movable elements are independent, the controlling module being configured to command the operating then the disabling of the hydraulic machine:
   the vehicle being in movement, the flushing being provided by the circulation of the hydraulic fluid upon the transmission of the movements of the drive torque to the movable elements of the operated hydraulic machine, or
   the vehicle being stopped, the flushing being partly provided by the movements of the starting movable elements during the successive operating and disabling of the hydraulic machine,
the starting movable elements are dependent, the controlling module being configured to command the operating then the disabling of the hydraulic machine:
   the vehicle being in movement, the flushing being provided by the circulation of the hydraulic fluid upon the transmission of the movements of the drive torque to the movable elements of the operated hydraulic machine, or
   the vehicle being stopped, the flushing being provided by the movements of the starting movable elements during the successive operating and disabling of the hydraulic machine,
the hydraulic machine is a hydraulic power pump linked to a powertrain of the vehicle,
the hydraulic machine is a hydraulic motor linked to a wheel of the vehicle, and
the hydraulic assistance device comprises:
   a first hydraulic machine, and
   a second hydraulic machine,
   the fluid inlet of the first machine being put in fluid communication with the fluid outlet of the second machine, and
   the fluid inlet of the second machine being put in fluid communication at the fluid outlet of the first machine,
the controlling module being configured to command the operating then the disabling of the first hydraulic machine independently of the operating then the disabling of the second hydraulic machine.

The invention also relates to a vehicle comprising a hydraulic assistance device, and further comprising a self-maintenance system as previously described.

The invention further relates to a self-maintenance method of a hydraulic assistance device of a vehicle, said device comprising a hydraulic machine, said hydraulic machine comprising:
a fluid inlet,
a fluid outlet, and
elements which are movable under the action of a hydraulic fluid circulating within the hydraulic machine,
   said hydraulic machine being configured to:
convert a pressure difference between the fluid inlet and the fluid outlet into a drive torque, and reciprocally, such as to provide the hydraulic assistance, the conversion being implemented by the movement of movable elements, and
be alternatively:
   operated such as to engage the hydraulic assistance, or
   disabled such as to disengage the hydraulic assistance, the operating and the disabling being also provided by the movement of starting movable elements, and the engagement and the disengagement of the assistance being controllable on command,
      the method comprising the steps consisting in
operating the hydraulic machine for a determined time period, then
disabling the hydraulic machine at the end of said time period so as to provide the flushing of all or part of the hydraulic machine, the steps of operating and disabling being implemented independently of a command of engagement and/or disengagement of the assistance, the method being implemented by a self-maintenance system previously described.

The method according to the invention can further comprise the following features taken alone or in combination:
it is implemented for a given range of vehicle speeds, for example the vehicle speed being between 0 and 40 km/h,
the steps of operating and disabling are successively repeated with a given frequency,
it is implemented starting from a given level of wear of the hydraulic fluid,
it is implemented each time the vehicle is started up, and
it is implemented at a given rate, said rate being
   either functional, for example each time the vehicle has travelled a given distance, and/or
   temporal, for example once every month of operation of the vehicle.

### BRIEF DESCRIPTION OF THE FIGURES

Other features, aims and advantages of the present invention will become apparent on reading the following detailed description and with reference to the appended drawing given by way of non-limiting example and wherein:

FIGS. 1a to 1f schematically illustrate different embodiments of a self-maintenance system of a hydraulic assistance device of a vehicle,

FIGS. 2a and 2b schematically illustrate different embodiments of a hydraulic assistance device of a vehicle,

FIG. 3 illustrates different steps of a method of self-maintenance of a hydraulic assistance device of a vehicle, and

FIGS. 4a and 4b show functional diagrams of different embodiments of a method of self-maintenance of a hydraulic assistance device of a vehicle.

### DETAILED DESCRIPTION OF THE INVENTION

With reference to the figures, there now follows a description of a self-maintenance system 1 of a hydraulic assistance device 2 of a vehicle.

In the remainder of the text, the term “self-maintenance” is understood to mean all the actions automatically implemented by a system 1 as described, for the purpose of ensuring the constant availability of the functions of a hydraulic assistance device 2 of a vehicle. As will be explained in more detail, the self-maintenance of a hydraulic assistance device 2 comprises the regular defouling of the different elements of the device 2, such as the filters 101, 103 or the areas where there are deposits, by circulating the hydraulic fluid within the device 2. The self-maintenance also comprises the renewal and the regular homogenization of the hydraulic fluid, by stirring and mixing, for the purpose of avoiding stagnation of fluid, particularly in the portions of elements of the device 2 which are close to a hot element of the vehicle.

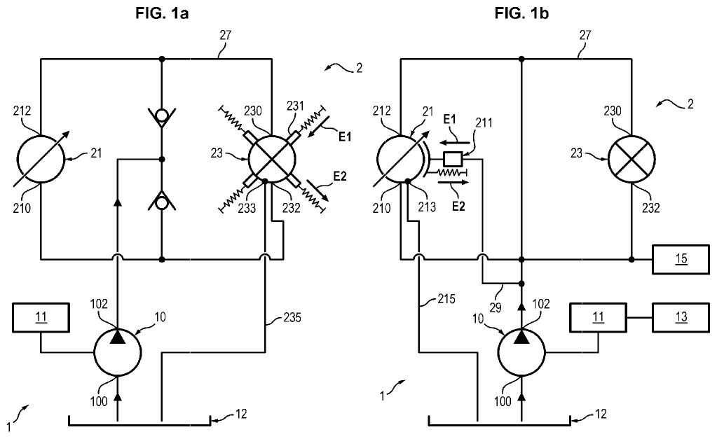

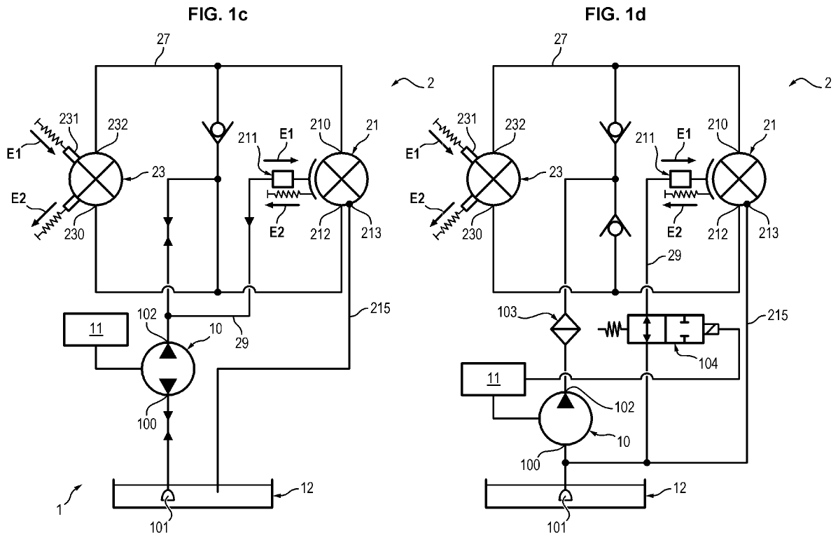

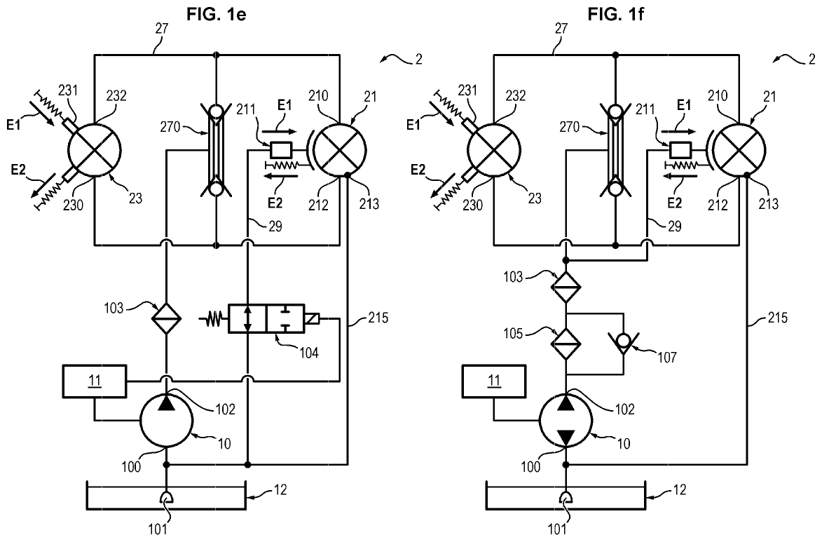

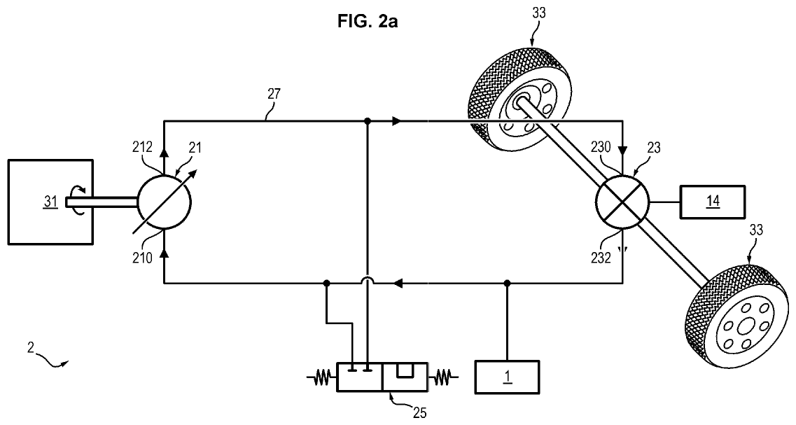

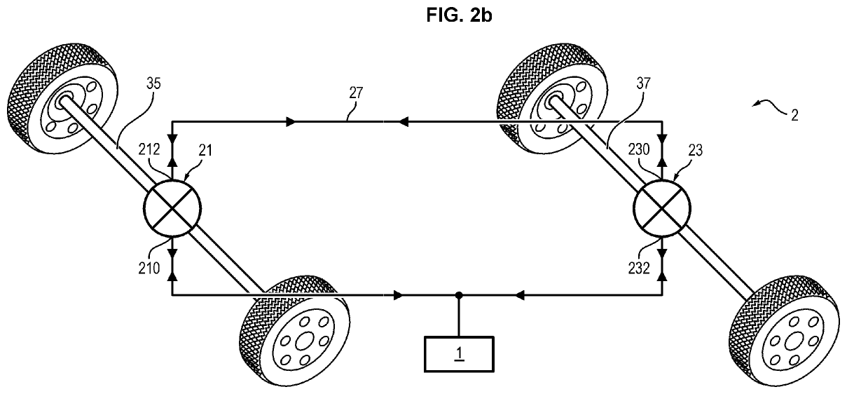

With reference to FIGS. 1a to 1f, 2a and 2b, a hydraulic assistance device 2 of a vehicle comprises a hydraulic machine 21, 23.

The hydraulic machine 21, 23 comprises a fluid inlet 210, 230 and a fluid outlet 212, 232, and mechanical elements movable under the action of a hydraulic fluid circulating within the hydraulic machine 21, 23. The fluid inlet 210, 230 and outlet 212, 232 are generally put in fluid communication with a hydraulic assistance circuit 27. Such a machine 21, 23 is then configured to convert a pressure difference between the fluid inlet 210, 230 and the fluid outlet 212, 232 into a drive torque, and reciprocally, the conversion being implemented by the movement of movable elements of the hydraulic machine 21, 23. This conversion further makes it possible to provide the function of hydraulic assistance of the device 2.
The hydraulic machine 21, 23 is also configured to be alternatively operated or disabled, the operating and the disabling respectively providing the engagement and the disengagement of the hydraulic assistance. With regard to this, the hydraulic machine 21, 23 comprises starting movable elements 211, 231 also movable under the action of a hydraulic fluid circulating within the hydraulic machine 21, 23. By way of non-limiting example, such movable elements 211, 231 can be clutches 211 with disks or dogs, for example of the same type as the gearbox state of the art. In this case, the starting movable elements 211 are linked to a different fluid circuit 29 from the hydraulic assistance circuit 27, and their movement is independent from the other movable elements of the hydraulic machine 21. These are referred to as “independent” starting movable elements 211. Alternatively such elements can be radial pistons 231 that disengage from their cam by retraction of the pistons 231. In this case, the starting movable elements 231 are directly linked to the hydraulic assistance circuit 27. Their movement is dependent of the other movable elements of the hydraulic machine, or is even the same elements 231. These are referred to as “dependent” starting movable elements 231. The operating and disabling of such machines 21, 23 are for example described in the patent applications FR 2 996 267 and FR 3 033 529 in the name of the Applicant, and will not be further detailed here. The hydraulic machine 21, 23 generally possesses a casing drain 215, 235, which collects the internal leaks of all the members of the machine 21, 23 subjected to pressure, and sends them back to an oil reservoir 12. More particularly, the hydraulic machine 21, 23 can possess a leak nozzle 213, 233 intended to renew the oil, and to cool certain internal members, which is linked to a drain 215, 235 by which the excess hydraulic fluid can be expelled toward the reservoir 12.

Still with reference to FIGS. 1a to 1f, 2a and 2b, a vehicle endowed with such a hydraulic assistance device 2 comprises a self-maintenance system 1 for the device 2. This system 1 particularly comprises a controlling module 11 configured to command the hydraulic assistance. More precisely, the controlling module 11 is configured to receive a command of engagement or disengagement of the hydraulic assistance and transmit a corresponding command of operating or disabling of the hydraulic machine 21, 23.

The engagement and the disengagement of the assistance is controllable on command. With regard to this, the command of engagement or disengagement of the hydraulic assistance can be transmitted to the controlling module 11 directly by a user. Alternatively such a command can be transmitted by an automaton 13 of the vehicle according to the driving conditions. Typically, the automaton 13 requires the hydraulic assistance when a skid is detected, for example when the vehicle is tackling snowy or sandy surfaces. In the same way, the automaton 13 cuts off the hydraulic assistance when the speeds attained by the vehicle are greater than a level permissible by the hydraulic machine 21, 23.
The controlling module 11 is further configured to command the operating of the hydraulic machine 21, 23 during a determined time period, then the disabling of the hydraulic machine 21, 23 at the end of the determined operating period, said command being independent of, respectively, an engagement or disengagement command of the assistance. More precisely, the controlling module 11 is configured to control the operation of the hydraulic assistance device 2 alternatively in response to a command of engagement or disengagement, or on its own initiative, for self-maintenance purposes, without having received an engagement and/or disengagement command. Specifically, the operating of the hydraulic machine 21, 23 during a determined time period, then the disabling of the hydraulic machine 21, 23, ensure the setting in movement of movable elements of the hydraulic machine 21, 23 to force the circulation of hydraulic fluid within all or part of the hydraulic machine 21, 23. This is referred to as complete or partial flushing of the hydraulic machine 21, 23. The regular self-maintenance of the hydraulic assistance device 2 is thus advantageously made possible.

With reference to FIG. 2a, the hydraulic machine can be a hydraulic power pump 21. In this case, the power pump 21 is linked, for its drive, to a powertrain 31 of the vehicle. The movable elements of the power pump 21 are then configured so that their movements make it possible to convert the torque supplied by the powertrain 31 into a pressure difference between the fluid inlet 210 and outlet 212 of the power pump 21.

Alternatively, still with reference to FIG. 2a, the hydraulic machine is a hydraulic motor 23. The motor 23 is linked to a wheel 33 of the vehicle. The movable elements of the motor 23 are then configured so that their movements make it possible to convert a pressure difference between the fluid inlet 230 and outlet 232 of the motor 23 into a torque transmitted to the wheel 33, when the assistance is engaged. The wheel 33 is typically a supporting wheel not linked to the mechanical transmission of a 4×2 vehicle. When the assistance is disengaged and the vehicle is in movement, the motor 23 being moreover operated, the movable elements can be set in movement under the action of the torque exerted by the wheel 33 in rotation. However, there is in general a vehicle speed limit above which a safety module 14 of the hydraulic assistance device 2 automatically disables the hydraulic motor 23, to preserve the safety of the motor 23.

With reference to FIG. 2a, the hydraulic assistance device can also comprise a first hydraulic machine 21 and a second hydraulic machine 23, the inlet 210 of the first machine 21 being put in fluid communication with the outlet 232 of the second machine 23, and the inlet 230 of the second machine 23 being put in fluid communication at the outlet 212 of the first machine 21.

Typically, the first machine 21 can be a hydraulic power pump, whereas the second hydraulic machine 23 can be a hydraulic motor. The hydraulic circuit linking the power pump 21 to the motor then advantageously comprises a bypass valve 25. The controlling module is thus configured to command the operating then the disabling of the first hydraulic machine 21 independently of the operating then the disabling of the second hydraulic machine 23.
Alternatively, with reference to FIG. 2b, the device 2 is of “chain drive” type. In this case, the first hydraulic machine 21 is linked to the front axle 35 of the vehicle, and the second hydraulic machine 23 is linked to the rear axle 37 of the vehicle. The first machine 21 and the second hydraulic machine 23 can then be configured to alternatively provide the power pump or motor function, according to the needs for additional drives required by one or the other of the axles 35, 37. The controlling module 11 is then configured to implement the operating and/or the disabling of the machines 21, 23 simultaneously.

Different embodiments of a self-maintenance system 1 of a hydraulic assistance device of a vehicle will now be described, with reference to FIGS. 1a to 1f.

A hydraulic assistance device 2 generally comprises a reservoir 12 and a feed pump 10, the feed pump 10 comprising:
a fluid inlet 100 put in fluid communication with the reservoir 12, and
a fluid outlet 102 put in fluid communication with the hydraulic machine 21, 23,
   The feed pump 10 can be electrical or be linked to the powertrain 31 of the vehicle. The feed pump 10 is moreover configured to make a hydraulic fluid circulate alternatively:
from the reservoir 12 to the hydraulic machine 21, 23 to operate the hydraulic machine 21, 23 such as to set in movement therein the starting movable elements 211, 231, and to maintain therein a sufficient pressure to maintain the machine 21, 23 in operation, and
from the hydraulic machine 21, 23 to the reservoir 12 to disable the hydraulic machine 21, 23, thus causing a decrease in the pressure inside the hydraulic machine 21, 23 and also setting in movement the starting movable elements 211, 231.

Typically, with reference to FIGS. 1a, 1d and 1e the hydraulic machine 23, 21 possesses a fluid inlet 230, 210 put in fluid communication with the fluid outlet 102 of the feed pump 10, and a fluid outlet, for example the leak nozzle 233, 213, put in fluid communication with the reservoir 12, for example by means of the drain 235, 215. In this case, the controlling module 11 commands the operating of the hydraulic machine 23 through activation of the feed pump 10 which outputs the hydraulic fluid into the hydraulic machine 23. In the same way, the controlling module 11 commands the disabling of the hydraulic machine 23 by disabling of the feed pump 10, which causes the expulsion of the fluid from the hydraulic machine 23 to the reservoir 12, via the drain 235.

Alternatively, with reference to FIGS. 1c and 1f, the hydraulic machine 23, 21 possesses a fluid inlet-outlet opening 230, 210 put in fluid communication with the fluid outlet 102 of the feed pump 10, the feed pump 10 furthermore operating by counter-rotation, i.e. it is configured to output hydraulic fluid from the reservoir 12 to the hydraulic machine 23 and reciprocally, by way of a single fluid communication duct. The operation of such a feed pump 10 is for example described in the patent application FR 3 033 529 in the name of the Applicant. In this case the controlling module 11 commands the operating of the hydraulic machine 23 through activation of the feed pump 10 in a first direction of output, and the disabling through activation of the feed pump 10 in a second direction of output, opposite to the first direction.

Advantageously, with reference to FIG. 1c to 1f, the feed pump 10 comprises a strainer 101 arranged between the reservoir 12 and the fluid inlet 100 of the feed pump 10, and a main filter 103 arranged between the outlet 102 of the feed pump 10, and the hydraulic assistance circuit 27. The strainer 101 and the main filter 103 filter the fluid coming from the reservoir 12, so as to preserve the hydraulic assistance device 2 from the ingestion of particulate contaminants. The strainer 101 and the main filter 103 are particularly useful when the hydraulic fluid is worn and/or has been subjected to high temperatures.

However, the strainer 101 and the main filter 103 tend to become clogged after the hydraulic assistance device 2 has been operational for a certain amount of time. The operation of the controlling module 11 of the self-maintenance system 1 then makes it possible, in addition to the flushing of the hydraulic machine 21, 23, to unclog the strainer 101 and/or the main filter 103.

In an embodiment of the self-maintenance system 1 illustrated in FIG. 1c, it is the operating and the successive disabling of the hydraulic machine 21, 23, by successive activation of the feed pump 10 in two opposite directions of output, which provides the circulation of the hydraulic fluid through the strainer 101 successively in two opposite directions of circulation. At the moment of disabling of the hydraulic machine 21, 23, the reverse flow of hydraulic fluid makes it possible to unclog the strainer 101 by releasing the impurities that it has accumulated into the reservoir. In another embodiment illustrated in FIG. 1d, the feed pump 10 operates conventionally, and the self-maintenance system 1 further comprises a vacuum valve 104 commanded by the controlling module 11. The vacuum valve 24 is used to drain all or part of the hydraulic assistance circuit 27, preferably by being linked to the high-pressure branch of the most likely hydraulic assistance circuit 27 (i.e. as illustrated in FIG. 1d, when driving forwards), and/or the independent movable elements 211. To do this, the vacuum valve 104 is movable between a passing position and an insulating position, on the command of the controlling module 11. In this case, the controlling module 11 commands the operating of the hydraulic machine 21, 23 through activation of the feed pump 10 which outputs the hydraulic fluid into the hydraulic machine 21, 23, the vacuum valve 104 being insulating. In the same way, the controlling module 11 commands the disabling of the hydraulic machine 21, 23 by disabling of the feed pump 10 and commands the vacuum valve 104 in passing mode, which causes the expulsion of the fluid from the hydraulic machine 23, 21 toward the reservoir 12, via the drain 215 and the fluid circuit 29, both linked to the strainer 101. The return flow of hydraulic fluid makes it possible to unclog the strainer 101 by releasing into the reservoir the impurities that it has accumulated. Alternatively, the feed pump 10 is of counter-rotation type, and the operating as well as the successive disabling of the hydraulic machine 21, 23, by successive activation of the feed pump 10 in two opposite directions of output provides the circulation of the hydraulic fluid through the strainer 101 and the main filter 103 successively, in two opposite directions of circulation.
In an alternative embodiment illustrated in FIG. 1e, the self-maintenance system 1 comprises, in addition to the vacuum valve 104, a low pressure selector switch 270 (or “inverse shuttle valve”) linking the two lines of the hydraulic assistance circuit 27 to the feed line. This makes it possible to feed the line of the hydraulic assistance circuit 27 which always has the lowest pressure. The selector switch 270 leaves permanently open the lowest pressure line with the feed line. Such a selector switch 270 is for example described in application FR 3 033 529 in the name of the Applicant and will not be further detailed here. Thus, the controlling module 11 commands the operating of the hydraulic machine 21, 23 through activation of the feed pump 10 which outputs the hydraulic fluid into the hydraulic machine 21, 23, the vacuum valve being insulating. In the same way, the controlling module 11 commands the disabling of the hydraulic machine 21, 23 by disabling of the feed pump 10 and commands the vacuum valve 104 in passing mode. On the one hand, this causes the expulsion of the fluid from the high pressure line of the hydraulic assistance circuit 27 and from the hydraulic machine 21, 23 toward the reservoir 12, via the fluid circuit 29 and the drain 215 respectively, both linked to the strainer 101. On the other hand, this causes the expulsion of the fluid from the low pressure line of the hydraulic assistance circuit 27 toward the reservoir 12, via the main filter 103. An unclogging of the main filter 103 and the strainer 101 is then advantageously obtained by these return flows. Alternatively, the feed pump 10 is of counter-rotation type, and the operating as well as the successive disabling of the hydraulic machine 21, 23, by successive activation of the feed pump 10 in two opposite directions of output provides the circulation of the hydraulic fluid through the strainer 101 and the main filter 103 successively, in two opposite directions of circulation.
In an embodiment illustrated in FIG. 1f, the self-maintenance system 1 comprises, further to the low pressure selector switch 270, a secondary filter 105 arranged between the main filter 103 and the outlet 102 of the feed pump 10. Parallel to the secondary filter 105 is a by-pass valve 107. Furthermore, the fluid circuit 29 for placing the independent movable elements 211 in a vacuum is linked to the outlet of the main filter 103. Thus, when the controlling module 11 commands the operating of the hydraulic machine 21, 23 through activation of the feed pump 10 which outputs the hydraulic fluid into the hydraulic machine 21, 23, the flow passes through the valve 107. Then, when the controlling module 11 disables the feed pump 10, the fluid flows back from the fluid circuit 29 and the low pressure line via the selector switch 270 through the main filter 103 which then discharges its impurities into the secondary filter 105. Alternatively, the feed pump 10 is of counter-rotation type, and the operating as well as the successive disabling of the hydraulic machine 21, 23, by successive activation successive of the feed pump 10 in two opposite directions of output, provides a circulation of the hydraulic fluid through the main filter 103 successively, in two opposite directions of circulation, with the retention of the impurities on return by the secondary filter 105.

In any case, in a system 1 configured to provide continuous self-maintenance of the hydraulic assistance device 2, the controlling module 11 commands the feed pump 10 and/or the vacuum valve 104 preferably independently of a command of engagement or disengagement of the traction assistance of the vehicle. This permits the fluid flushing of all or part of the hydraulic machine 21, 23 and/or the unclogging of the strainer 101 and of the main filter 103 which are regular, even if the assistance is not moreover required. Furthermore, for the operating and the rapid disabling of the hydraulic assistance, it is preferable that the self-maintenance system 1 comprises the vacuum valve 104 and/or the feed pump of counter-rotation type 10.

In a first embodiment, with reference to FIGS. 1b and 1c to 1f, the starting movable elements 211 are independent, for example constitute a disk clutch 211, making it possible to engage or disengage the machine 21 from its drive shaft (not shown).

The controlling module 11 is then configured to command the operating then the disabling of the hydraulic machine 21:
the vehicle being in movement, the flushing being provided by the circulation of the hydraulic fluid upon the transmission of the movements of the drive torque of the powertrain 31 or of the wheel 33 to the elements of the operated machine 21, or
the vehicle being stopped, the flushing being partly provided by the sole movements of the starting movable elements 211 during the successive operating and disabling of the hydraulic machine 21.
   The controlling module 11 commands the operating and/or the disabling of the hydraulic machine 21 in particular independently of a command of engagement and/or disengagement of the assistance. This permits the partial or complete flushing of the hydraulic machine 21, even if the assistance is not moreover required.

In a second embodiment, with reference to FIGS. 1a and 1c to 1f, the starting movable elements 231 are dependent, and for example comprise retractable radial pistons 231.

The controlling module 11 is then configured to command the operating then the disabling of the hydraulic machine 23:
the vehicle being in movement, the flushing being provided by the circulation of the hydraulic fluid upon the transmission of the movements of the drive torque of the powertrain 31 or of the wheel 33 to the movable elements of the operated hydraulic machine 23, or
the vehicle being stopped, the flushing being provided by the movements of the starting movable elements 231 during the successive operating and disabling of the hydraulic machine 23.
   In the same way as in the first embodiment, the controlling module 11 commands the operating and/or the disabling of the hydraulic machine 23 in particular independently of a command of engagement and/or disengagement of the assistance. This permits the more complete flushing of the hydraulic machine 23, in particular if the assistance is required and the machine performs a full revolution.

In any case, with reference to FIG. 1b, the controlling module 11 can advantageously comprise an automaton 13 configured to automatically implement a self-maintenance method E of a hydraulic assistance device 2.

Furthermore, still with reference to FIG. 1b, the controlling module 11 can comprise a module 15 for estimating the level of wear of the hydraulic fluid. This module 15 can for example measure the amperage of the current consumed by the feed pump 10. This is because the wear of the hydraulic fluid is directly correlated with the power needed to pressurize the hydraulic assistance circuit 27. Alternatively, this module 15 can estimate the level of wear of the hydraulic fluid based on the condition of ageing thereof. The condition of ageing of a hydraulic fluid is characterized by several parameters, including the shearing of the fluid, the oxidization of the fluid, and its particulate contamination. The knowledge of all these parameters, alone or in combination, and their variation during the operation of the hydraulic assistance device 2, in particular makes it possible to estimate the viscosity of the hydraulic fluid as a function of its temperature. The viscosity of the hydraulic fluid can also be determined directly by sensors configured for this purpose. In any case, the controlling module 11 is always configured to receive an item of information relating to the condition of wear of the hydraulic fluid.

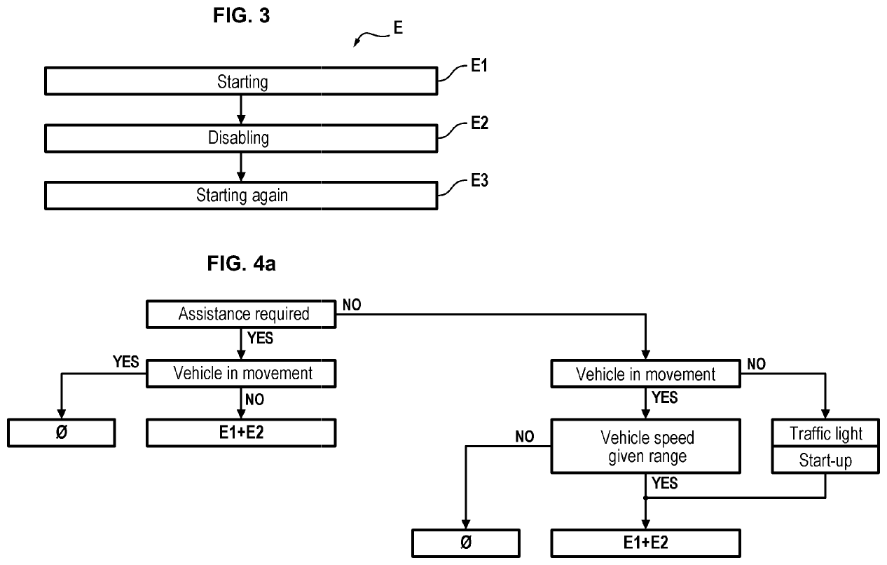

With reference to FIG. 3, there now follows a description of a self-maintenance method E of a hydraulic assistance device 2 of a vehicle, the self-maintenance method E being implemented by a self-maintenance system 1 as claimed in any one of the previously described embodiments.

Such a method E comprises the steps consists in:
operating E1 the hydraulic machine 21, 23 during a determined time period, then
disabling E2 the hydraulic machine 21, 23 at the end of said time period.
   This ensures the flushing of all (complete flushing) or part (partial flushing) of the hydraulic machine 21, 23 by the setting in movement of the movable elements to force the circulation of hydraulic fluid, the steps of operating E1 and disabling E2 being furthermore implemented independently of the command of engagement and/or disengagement of the assistance. This provides the regular self-maintenance of the hydraulic assistance device 2, even if the assistance is not moreover required, particularly if it is rarely required.

Advantageously, the step of disabling E2 can also be implemented by the safety module 14 for the purpose of preserving the safety of the hydraulic machine 21, 23 when the vehicle reaches too high a speed.

Even more advantageously, the alternating of the steps of operating E1 and disabling E2 is repeated successively with a given frequency, for example ten times in a row, such as to homogenize the flushing of the hydraulic machine 21, 23. This alternating can be preset by a user or the manufacturer.

The duration of the step of operating E1 can be preset by the manufacturer of the self-maintenance system 1. Alternatively, if the hydraulic machine 23 is linked to a vehicle wheel 33, the hydraulic machine 23 is operated during a time period corresponding to one wheel revolution 23.

Advantageously, the method E is implemented at a given rate, said rate being either functional and/or temporal, for example once every month of operation of the vehicle. The term “functional rate” is understood to mean that the method E is implemented at a rate that depends on the way in which the hydraulic assistance device 2 is used, for example each time the vehicle has travelled a given distance, when the vehicle reaches a defined rate of use or rate of load, or when pressure thresholds are reached in the hydraulic assistance circuit 27.

Advantageously, the method E is implemented based on a given level of wear of the fluid.

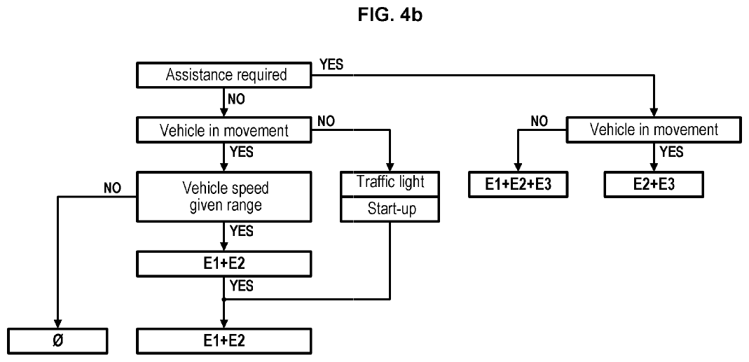

In a first embodiment of the method E, with reference to FIG. 4a, the assistance is moreover not required.

In this case, if the vehicle is in movement, then the method is implemented for a given range of vehicle speed, for example the speed of the vehicle being between 0 and 40 km/h. Beyond a certain level of vehicle speed, operating the hydraulic machine on a wheel can cause said machine to deteriorate.
Alternatively, the method E can be implemented while the vehicle is stopped, typically at traffic lights, preferably each time the vehicle is started up. This has the advantage of not interfering with the driving of the vehicle. In this case, if the starting movable elements 211 are independent, then the flushing is only partial.
Preferably, the step of operating E1 is implemented over a time period corresponding to a complete rotation of a hydraulic machine 21, 23 of the vehicle, which makes it possible to make all the parts move, and to entirely renew the hydraulic fluid contained in the cylinders of the machine 21, 23, but also to make the hydraulic fluid circulate in the ducts more completely. In particular if one rotation of a machine 21, 23 corresponds to one revolution of a wheel 33, the time period will correspond to one complete rotation of a wheel 33.

In a second embodiment of the method E, still with reference to FIG. 4a, the assistance is moreover required.

In this case, if the vehicle is in movement, the method E is not implemented, and the flushing is provided by the nominal operation of the hydraulic assistance device 2.

Alternatively, the method E can be implemented while the vehicle is stopped, typically at traffic lights, preferably each time the vehicle is started up. In this case, if the starting movable elements 211 are independent, then the flushing is only partial.

In a third embodiment of the method E, with reference to FIG. 4b, the assistance device comprises a reservoir 12, a feed pump, preferably with counter-rotation 10 and a set of filters, for example a strainer 101 and a main filter 103, as previously described. In this embodiment, besides the flushing of the hydraulic machine, the unclogging of the filters 101, 103 is advantageously obtained.

The method E then comprises the steps consisting in operating E1 the hydraulic machine 21, 23 during a determined time period, for example through activation of the feed pump 10, and in disabling E2 the hydraulic machine 21, 23, at the end of the step of operating E1, such as to make hydraulic fluid circulate through the filters 101, 103 successively, in two opposite directions of circulation. As previously described, the disabling E2 can be implemented by disabling of the feed pump 10, and backflow of the hydraulic fluid to the reservoir 12, or through activation of the feed pump 10 in the opposite direction, if it is of counter-rotation type. Furthermore, as previously described, the steps of operating E1 and disabling 2 are implemented independently of a command of engagement and/or disengagement of the assistance.

Advantageously, the method E can then be implemented with the assistance being moreover required. In this case, if the vehicle is in movement, the step of disabling E2 momentarily cuts off the assistance. The method E then makes provision for a step of operating again E3 following the step of disabling E2, such as to ensure the safety of the vehicle. Preferably, the step of disabling E2 is implemented over a time period corresponding to one rotation of the wheel 33 of the vehicle. In particular if one rotation of a machine 21, 23 corresponds to one revolution of a wheel 23, the time period will correspond to one complete rotation of a wheel 23.

The method E allows the regular setting in movement of the parts of the hydraulic assistance device 2, even if it is not used, which prevents wear or corrosion localized at the points of contact of immovable parts, avoids the existence of immovable hydraulic fluid which could undergo repeated heat cycles, and prevents the sedimentation or polymerization of the hydraulic fluid. Also, it allows the unclogging of filters 101, 103. By its effects, it makes it possible to keep the hydraulic assistance device 2 operational for longer, between two intervals of drainage of the hydraulic fluid. It can furthermore make it possible to space the drainage dates apart, and therefore reduce the operating costs of the system.

The self-maintenance system 1 can be used for the benefit of any hydraulic assistance traction device, particularly to convert a 4×2 vehicle into a 4×4 vehicle, or to assist the supporting wheels of a vehicle, for example the drive wheels of a truck, the supporting axles of trucks or trailers, the supporting axles of building site or agricultural machinery, of low-speed temporary hydraulic transmissions for service or work vehicles, designated by the name of “creep drive”, or road/rail convertible vehicles or machinery.

1. A self-maintenance system (1) of a hydraulic assistance device (2) of a vehicle, said device (2) comprising a hydraulic machine (21, 23), said hydraulic machine (21, 23) comprising:
a fluid inlet (210, 230),
a fluid outlet (212, 232), and
elements movable under the action of a hydraulic fluid circulating within the hydraulic machine (21, 23),
said hydraulic machine (21, 23) being configured to:
convert a pressure difference between the fluid inlet (210, 230) and the fluid outlet (212, 232) into a drive torque, and reciprocally, such as to provide the hydraulic assistance, the conversion being implemented by the movement of movable elements, and
be alternatively:
operated such as to engage the hydraulic assistance,
disabled such as to disengage the hydraulic assistance, the operating and the disabling being provided by the movement of starting movable elements (211, 231), and the engagement and disengagement of the assistance being controllable on command,
the system (1) comprising a controlling module (11) configured to command the operating of the hydraulic machine (21,23) during a determined time period, then command the disabling of the hydraulic machine (21, 23) at the end of said time period such as to ensure the flushing of all or part of the hydraulic machine (21, 23), said operating and disabling commands being independent of a command of engagement and disengagement of the assistance.

2. The system (1) as claimed in claim 1, wherein the device (2) further comprises:
a reservoir (12), and
a feed pump (10), the feed pump (10) comprising:
a fluid inlet (100) put in fluid communication with the reservoir (12), and
a fluid outlet (102) put in fluid communication with the hydraulic machine (21, 23),
the device (2) being configured to circulate the hydraulic fluid alternatively:
from the reservoir (12) to the hydraulic machine (21, 23), through activation of the feed pump (10), to operate the hydraulic machine (21, 23), and
from the hydraulic machine (21, 23) to the reservoir (12) to disable the hydraulic machine (21, 23).
the controlling module (11) being configured to command the feed pump (10).

3. The system (1) as claimed in one of claim 1 or 2, wherein the starting movable elements (211) are independent, the controlling module (11) being configured to command the operating then the disabling of the hydraulic machine (21, 23):
the vehicle being in movement, the flushing being provided by the circulation of the hydraulic fluid upon the transmission of the movements of the drive torque to the movable elements of the operated hydraulic machine (21, 23), or
the vehicle being stopped, the flushing being partly provided by the movements of the starting movable elements (211) during the successive operating and disabling of the hydraulic machine (21, 23).

4. The system (1) as claimed in one of claim 1 or 2, wherein the starting movable elements (231) are dependent, the controlling module (11) being configured to command the operating then the disabling of the hydraulic machine (21, 23):
the vehicle being in movement, the flushing being provided by the circulation of the hydraulic fluid upon the transmission of the movements of the drive torque to the movable elements of the operated hydraulic machine (21, 23), or
the vehicle being stopped, the flushing being provided by the movements of the starting movable elements (231) during the successive operating and disabling of the hydraulic machine (21, 23).

5. The system (1) as claimed in one of claims 1 to 4, wherein the hydraulic machine (21, 23) is a hydraulic power pump (21) linked to a powertrain (31) of the vehicle.

6. The system (1) as claimed in one of claims 1 to 5, wherein the hydraulic machine (21, 23) is a hydraulic motor (23) linked to a wheel (33) of the vehicle.

7. The system (1) as claimed in one of claims 1 to 6, wherein the device (2) comprises:
a first hydraulic machine (21), and
a second hydraulic machine (23),
the fluid inlet (210) of the first machine (21) being put in fluid communication with the fluid outlet (232) of the second machine (23), and
the fluid inlet (230) of the second machine (23) being put in fluid communication at the fluid outlet (212) of the first machine (21), the controlling module (11) being configured to command the operating then the disabling of the first hydraulic machine (21) independently of the operating then the disabling of the second hydraulic machine (23).

8. A vehicle comprising a hydraulic assistance device (2), and further comprising a self-maintenance system (1) as claimed in one of claims 1 to 7.

9. A self-maintenance method (E) of a hydraulic assistance device (2) of a vehicle, said device (2) comprising a hydraulic machine (21, 23), said hydraulic machine (21, 23) comprising:
a fluid inlet (210, 230),
a fluid outlet (212, 232), and
elements which are movable under the action of a hydraulic fluid circulating within the hydraulic machine (21, 23),
said hydraulic machine (21, 23) being configured to:
convert a pressure difference between the fluid inlet (210, 230) and the fluid outlet (212, 232) into a drive torque, and reciprocally, such as to provide the hydraulic assistance, the conversion being implemented by the movement of movable elements, and
be alternatively:
operated such as to engage the hydraulic assistance, or
disabled such as to disengage the hydraulic assistance, the operating and the disabling being provided by the movement of starting movable elements (211, 231), and the engagement and disengagement of the assistance being controllable on command,
the method (E1) comprising the steps consisting in
operating the hydraulic machine (21, 23) (E1) for a determined time period, then
disabling (E2) the hydraulic machine (21, 23) at the end of said time period so as to provide the flushing of all or part of the hydraulic machine (21, 23),
the steps of operating (E1) and disabling (E2) being implemented independently of a command of engagement and/or disengagement of the assistance, the method being implemented by a self-maintenance system (1) as claimed in any one of claims 1 to 7.

10. The method (E) as claimed in claim 9, wherein the method (E) is implemented for a given range of vehicle speeds, for example the vehicle speed being between 0 and 40 km/h.

11. The method (E) as claimed in one of claim 9 or 10, wherein the steps of operating (E1) and disabling (E2) are successively repeated with a given frequency.

12. The method (E) as claimed in one of claims 9 to 11, wherein the method (E) is implemented from a given level of wear of the hydraulic fluid.

13. The method (E) as claimed in one of claims 9 to 12, wherein the method (E) is implemented each time the vehicle is started up.

14. The method (E) as claimed in one of claims 9 to 13, wherein the method (E) is implemented at a given rate, said rate being
either functional, for example each time the vehicle has travelled a given distance, and/or
temporal, for example once every month of operation of the vehicle.
